(19) United States
(12) Patent Application Publication
(10) Pub. No.: US 2015/0066897 A1
(43) Pub. Date: Mar. 5, 2015

(54) SYSTEMS AND METHODS FOR CONVEYING PASSIVE INTEREST CLASSIFIED MEDIA CONTENT

(71) Applicant: eweware, inc., Santa Monica, CA (US)

(72) Inventors: David Vronay, Santa Monica, CA (US); Ruben Kleiman, Redwood City, CA (US)

(21) Appl. No.: 14/455,801

(22) Filed: Aug. 8, 2014

Related U.S. Application Data
(60) Provisional application No. 61/870,748, filed on Aug. 27, 2013.

(51) Int. Cl. G06F 17/30

(52) U.S. Cl. CPC G06F 17/30867
USPC 707/710

(57) ABSTRACT

The systems and methods for conveying automatic passive interest classified media content includes storing a plurality of media content items on a storage device, associating metadata with each of the media content items in the storage device, creating a media content subset from the plurality of media content items, conveying the media content subset over a communication network to an interactive presentation environment for consumption by a user, analyzing consumption of the media content subset by the user over the interactive presentation environment, modifying the media content subset from the plurality of media content items in the storage device in response to the analyzed user consumption.

### BACKGROUND OF THE INVENTION

The present invention relates to a systems and methods for automatically selecting and conveying a subset of content items from a larger collection of content items. More specifically, the present invention relates to systems and methods that observe consumer interaction with content items, then selects and conveys a subset of the larger collection of content items to the consumer based on the consumer's interaction with the content.

Computer systems have long been used as a medium to store and convey content, and are quickly becoming the preferred medium as storage capacities and outlet channels have increased dramatically in recent years. For example, a typical personal computer or tablet is relatively inexpensive and can easily hold hundreds of movies and thousands of pictures or songs, and business or professional computer servers can hold and convey vastly more content. When the amount of stored content exceeds a few dozen items, it becomes increasingly difficult to efficiently display relevant content items to the consumer. Consumers typically either do not want to view large quantities of content items or simply do not have time to consume large quantities of content items, much less all the content items in any particular group. Rather, consumers would rather consume the most relevant content items at any given point in time. For example, if a storage system contains 50,000 pictures, it may be too time consuming and probably impractical for the consumer to view even a fraction of the pictures (e.g., 10%-20%) in the database. Accordingly, computer systems typically display only a small subset of the total collection of content items available. In this example, the computer system may display a 100 picture subset from the total collection of 50,000 pictures. One challenge with this approach is determining which content items to include as part of the subset. Several methods for creating this content subset are known in the art; however, each method has drawbacks.

The most common method for creating a content subset is through a query or a “search”. Here, a consumer may enter one or more keywords or phrases into a query to conduct a search for metadata related to those keywords or phrases. The system preferably displays content items having relevant metadata matching or closely related to the keywords or phrases entered by the consumer as part of the search. For example, entering the keyword “basketball” into a streaming video service search box may search for videos having metadata matching or related to the search term “basketball”. This subset of videos (i.e., those having metadata matching or related to “basketball”) are displayed for consumer selection from the larger collection of videos.

This display method, however, has several drawbacks. For example, a consumer merely browsing a collection of content items may not be knowledgeable about what specific items are available and, therefore, fail to enter relevant keywords or phrases related to that content because the user lacks the proper knowledge related to the relevant search terms. This issue may be exacerbated should the consumer forget about previously created content, or if the user is unaware of other content created by a third party. For example, if a consumer wants to watch a movie but does not have a specific movie in mind, the consumer has no way of efficiently browsing the movie listings using keywords because the desired content is unknown. The consumer simply cannot devise search terms for something unknown and is relegated to two basic options: (a) use broad search terms by genre (e.g., comedy, drama, action, etc.) that may net hundreds or thousands of results that may or may not appeal to the consumer; or (b) enter random keywords, hoping to find someone of interest. Obviously, both of these processes are highly inefficient and undesirable.

Another method for creating a subset of content items involves consumer annotations. In this respect, a consumer may annotate (e.g., vote or rate) various content items in a collection of content items. The system can later present to the consumer a subset of items from the content collection based on the consumer annotations (e.g., movies the consumer voted for or rated with five stars). For example, a streaming video system may allow consumers to vote on movies and may then provide the consumer with a subset of the total movies available based on the voting. If the consumer tends to vote basketball movies more favorably than other types of sports movies, the subset would include more basketball movies and fewer movies relating to other sports. Additionally, this type of voting system could be used to determine what content items are initially shown to new consumers who have never voted on an item. For example, a positive vote may increase the rating of certain content, while a negative vote may decrease the content rating. New consumers (e.g., new members to the video streaming service) are shown only highly-rated content, while low-rated content may be displayed lower on the list, shown on subsequent pages, or not at all. Unfortunately, this method requires that the consumer regularly annotate content items, and preferably a large quantity of content items, as more annotations tend to produce better results. This is a tedious process that many consumers tend to neglect over time due to lack of time or patience. Moreover, some consumers may lose interest in the annotation process before fully experiencing the system's functionality as it can take several weeks or months to annotate enough content items to create relevant subsets.

A third approach is to have the system sort and display content items based on some objective measure (e.g., date created). For example, the system may sort the database of content items by date, and display only a subset of content items created in the last hour. This approach may be excellent for a blog or other similar website where the content consumer is likely interested in all or a substantial amount of the content items available, and has interest in following new content items as they are posted. But, if the consumer is only interested in a small fraction of the total available content items (e.g., as is typically the case with a streaming video or audio service), it will be difficult to locate relevant or interesting content items based only on objective criteria like the creation date. Alternatively, the objective criteria may be crowd-sourced information such as, inter alia, voting results, viewer ratings, number of downloads, or number of views. The system would similarly display all content items meeting a certain threshold value. For example, the system may display only videos with 100,000 or more views. Both approaches, however, are impersonal as no deference is given to the individual consumer's preferences, but rather the crowd as a whole.

Another approach involves letting consumers follow certain content producers identified as producing interesting or relevant content. This system allows consumers to add producers to a preferred list, and then automatically display only those content items created by the selected producers on the preferred list. One issue with this system is that consumers must search out and find the producers they want to follow. Again, a system that displays only content items from known producers may eliminate lesser or relatively unknown produces, even if those lesser or unknown producers may be producing content relevant or interesting to certain consumers. Thus, such a system does not allow consumers to discover new producers or their content.

Additionally, some conventional systems combine two or more of the aforementioned systems or methods to attempt to provide better results. For example, a system may provide a consumer with only highly rated content matching a specific keyword or phrase created after a specific date and created by a specific content producer listed on a preferred list. Such systems are capable of delivering highly personalized results to the consumer, but the consumer must provide continuous input to ensure optimal results. That is, the consumer must, inter alia, continuously enter search terms, manage the content producer preferred list, and vote on or rate content items. Over time this process becomes unsustainable and leads to a reduction in the quality of the content items displayed to the consumer. Moreover, the perceived quality of the overall system depreciates over time as more consumers are unable to maintain the level of input required to produce satisfactory results. Thus, regardless of the combinations, there is simply no way to balance the need for frequent consumer input and impersonal results. These systems either require extensive and unsustainable user input (e.g., annotation, creating preferred content producer lists, keyword discovery, etc.) or are reliant on crowd-sourced input that produces generalized and impersonal results.

Moreover, existing systems are also vulnerable to a variety of malicious activity. For example, voting systems are susceptible to tampering by fake accounts (e.g., created by a content producer) created solely for the purpose of voting or rating “up” or “down” certain content. In this respect, such fake accounts can have an adverse impact on the relevance of hundreds or even thousands of content items. Alternatively, computer viruses or malware (known as a “botnet”) may infect or hack user accounts, thereby allowing malicious consumers or producers to use controlled devices (“bots”) to vote on content items. Manipulating the voting system in this respect is representative of only a few, rather than representing the true popularity of the content.

Thus, there is a significant need in the art for systems and methods for creating and displaying a filtered subset of information to a consumer based on a larger collection of content items to maintain high-quality personal results without the extensive or exhaustive continuous input from the consumer. The present invention fulfills these needs and provides further related advantages.

### SUMMARY OF THE INVENTION

The systems and methods disclosed herein for conveying automatic passive interest classified media content include storing a plurality of media content items on a storage device and associating metadata with each of the media content items. A media content subset is then created from the plurality of media content items to be conveyed over a communication network to an interactive presentation environment for consumption by a user. The user can consume the media content in the subset by selecting, viewing or otherwise listening to the media content. The system analyzes the consumption patterns of the media content in the subset by the user, and preferably specifically with respect to the user's interaction with the presentation environment. In response, the media content subset may be modified by adding one or more media content items to the subset or removing one or more media content items from the subset, based on the consumption habits of the user.

For example, in a preferred embodiment, media content consumed or selected by the consumer is retained in the subset and other similar content may be added to the subset, while unrelated or unselected content may be removed from the subset. In this respect, the analyzing step preferably includes identifying consumption habits through user interaction with the interactive presentation environment and associating those habits as metadata with respect to the consumed media content items. This, accordingly, allows the system to modify the media content subset by removing unconsumed or less relevant media content items or adding relevant media content items based on comparisons and similarities among the metadata stored in association with each media content item.

The storage device preferably includes a local storage medium, a network-connected storage medium, or a cloud service. The plurality of media content items preferably include some form of consumable audio content (e.g., by listing to the content), visual content (e.g., by watching the content), or a combination of audio and visual content (e.g., a movie or sit-com). In one embodiment, the metadata may be uploaded to the system by the producer of the content. Here, the metadata is pre-loaded and may include producer metadata, consumer metadata or category metadata. Furthermore, the system may form a producer relevancy table categorically listing one or more content producers that create or upload content relevant to the interests of the user. The system is able to use the aforementioned metadata to associate the media content item with other media content items on the storage device to form a media content subset relevant to the user. Moreover, the creating step may include selecting one or more of the plurality of media content items for inclusion in the media content subset based on an input received from the user through the interactive presentation environment. In one embodiment, the input may be a keyword and the media content subset may include one or more media content items having metadata matching or substantially similar to the keyword.

In another embodiment as disclosed herein, the systems and methods include conveying automatic passive interest classified media content to a cohort. In this embodiment, the system stores a plurality of media content items and associated metadata on a storage device and creates a media content subset from the plurality of media content items based on similarities in the metadata. The cohort is formed from a plurality of users having similar consumption habits, i.e., similar interactions with the media content items presented as part of an interactive presentation environment. To this end, the media content items in the subset are conveyed to users over a communication network for consumption by the users of the cohort via the interactive presentation environment. The system analyzes the consumption habits of the media content subset by the users of the cohort over the interactive presentation environment and modifies the media content subset from the plurality of media content items in the storage device in response to the analyzed consumption habits of the media content subset by the users of the cohort.

Preferably, the system generates cohort metadata for each of the plurality of the media content items based on the consumption habits of the users in the cohort. This way, the system can better gauge which users are more relevant to the cohort and which users are less relevant. To this end, consumers with similar consumption habits may be added or retained within the cohort, while other consumers with dissimilar consumption habits may be excluded or removed from the cohort. Of course, a user may be assigned to multiple cohorts and cohort assignment may change over time as determined by individual user consumption and relative to consumption by other users. In a similar respect, the consumption habits of a user in a cohort may change in response to the consumption habits of the user with the media content subset via the interactive presentation environment. The system may also include or permit the formation of multiple cohorts and associate a producer relevancy table with each cohort.

In another alternative embodiment of the systems and methods disclosed herein, a method for conveying automatic passive interest classified media content to a user may include storing a plurality of media content items and associated metadata on a storage device, creating multiple media content subsets from the plurality of media content items, wherein the media content items in each of the media content subsets have related metadata. The one or more media content subsets are then conveyed over a communication network to at least one media inbox associated with the user through an interactive presentation environment. The system analyzes media inbox selection and consumption of the respective media content subsets therein by the user over the interactive presentation environment and modifies the consumed media inbox and media content subset based on user selection and consumption habits with the consumed inbox and the consumed content subset over the interactive presentation environment. The media inbox may include a consumer inbox and a cohort inbox, and the system may assign multiple media inboxes to a single user. Additionally, the conveying step may include conveying to the user a pre-selected inbox, a search inquiry inbox, an objective criteria inbox, or a manually selected inbox.

In another embodiment, the systems and methods for conveying automatic passive interest classified media content to a user in a feedback responsive presentation environment includes storing a plurality of media content items and associated metadata on a storage device, creating a media content subset from the plurality of media content items based on a consumption habit profile unique to the user, conveying the media content subset over a communication network to the feedback responsive presentation environment, analyzing interaction of the conveyed media content items from the media content subset by the user within the feedback responsive presentation environment, and modifying the consumption habit profile of the user in response to consumption or non-consumption of the media content items in the media content subset. The modifying step may further include modifying the media content items in the media content subset in response to modification of the consumption habit profile of the user. Additionally, the feedback responsive presentation environment preferably includes a continuously moving stream of the media content items, such as a horizontal stream, a vertical stream, or a manually scrollable stream. The media content items relatively more pertinent to the user are preferably more prominent in the feedback responsive interactive presentation environment than other media content items relatively less pertinent to the user.

The systems and methods disclosed herein may also include conveying automatic passive interest classified media content by way of storing a plurality of media content items and associated metadata on a storage device, extracting at least one feature from one or more of the media content items, and creating a media content subset from the plurality of media content items based at least in part on similar features extracted from the media content items. The media content subset is then presented over a communication network to an interactive presentation environment for consumption by a user. The consumption of the media content subset by the user over the interactive presentation environment is analyzed and the media content subset may be modified with the plurality of media content items from the storage device in response to the analyzed user consumption. The metadata associated with the media content item may be augmented with the feature, which may include a producer feature or a media content feature. Additionally, this method may further include the steps of comparing the extracted at least one feature with the metadata and supplementing the metadata with the extracted feature, when non-duplicative. Furthermore, the extracting step may include the step of extracting a first feature from the media content item with a first extractor and extracting a second feature from the media content item with a second extractor, wherein the system is able to weigh the relevancy of the first and second features based on the relevancy of the first and second extractors relative to the first and second features. Of course, a higher relevancy corresponds with a higher weight.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic view illustrating a preferred embodiment wherein the systems and methods disclosed herein select a media content subset from a plurality of media content items for display to a consumer;

FIG. 2 is a schematic view similar to FIG. 1, further illustrating the logic behind selecting and conveying the media content subset;

FIG. 3 is a flowchart illustrating a method for conveying the media content subset in accordance with one embodiment disclosed herein;

FIG. 4 is a schematic view illustrating a producer uploading media content to a storage device;

FIG. 5 is a schematic view illustrating an extractor extracting one or more media content features and a set of producer features from the plurality of media content items stored on the storage device;

FIG. 6A is a schematic view illustrating the use of multiple extractors simultaneously extracting the media content features and the producer features to create a set of media metadata and a set of producer metadata;

FIG. 6B is a schematic view illustrating an extractor determining which of a plurality of extractors should be used to extract the media content metadata and the producer metadata from the media content items;

FIG. 7 is a schematic view illustrating a content selector creating a subset of the plurality of media content items;

FIG. 8 is a schematic view of a cohort generator grouping the consumers into one or more cohorts;

FIG. 9 is a schematic view illustrating an inbox generator generating one or more inboxes and an inbox selector selecting and fetching the one or more inboxes for presentation to the consumer;

FIG. 10 is a diagrammatic view illustrating an inbox containing a mixture of high relevance, medium relevance, low relevance, and undermined relevance selected media content items;

FIG. 11 is a schematic view of a presentation environment presenting an inbox containing the media content subset to the consumer;

FIG. 12 is a diagrammatic view illustrating the presentation environment displaying selected media content items to the consumer in different sizes based on relevance;

FIG. 13 is a schematic view illustrating an analyzer analyzing a set of consumed selected media content items and saving the information obtained therefrom as a set of consumer metadata; and

FIG. 14 is a schematic view illustrating the system creating a producer relevancy table.

### DETAILED DESCRIPTION OF THE PREFERRED EMBODIMENTS

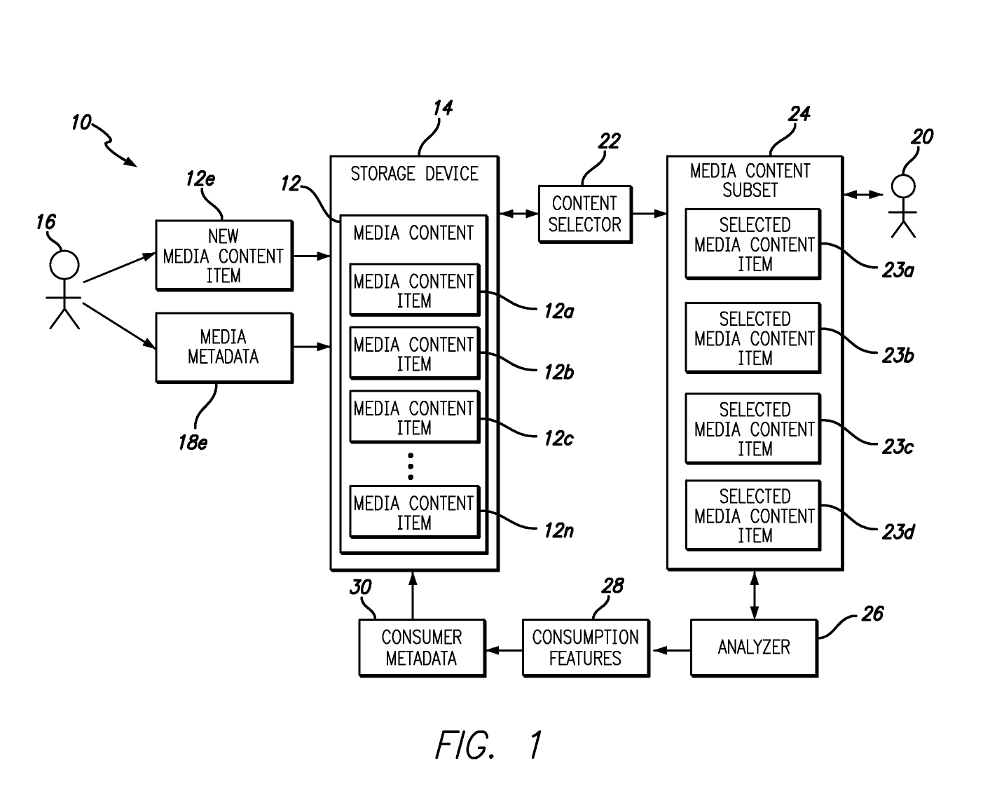

As shown in the drawings for the purposes of illustration, the present invention for the systems and methods for conveying content based on automatic passive interest classification is shown generally by reference numeral 10 in FIGS. 1-14. As illustrated in FIG. 1, the content conveyance system 10 includes a group of media content items 12 that may include individual media content items 12a, 12b, 12c . . . 12n stored on a storage device 14, such as a local hard drive or solid state drive, a network-connected storage device, a cloud service, or any other local or remote storage device known in the art. The media content items 12 may have virtually any structure or format known in the art including, inter a/ia, documents, text strings, pictures, videos, audio files, or any combination thereof. Of course, a single media content item could include one or more of the aforementioned structures or formats, and the system 10 could store and use media content items 12 having different structures and/or formats or different combinations of the aforementioned structures and/or formats.

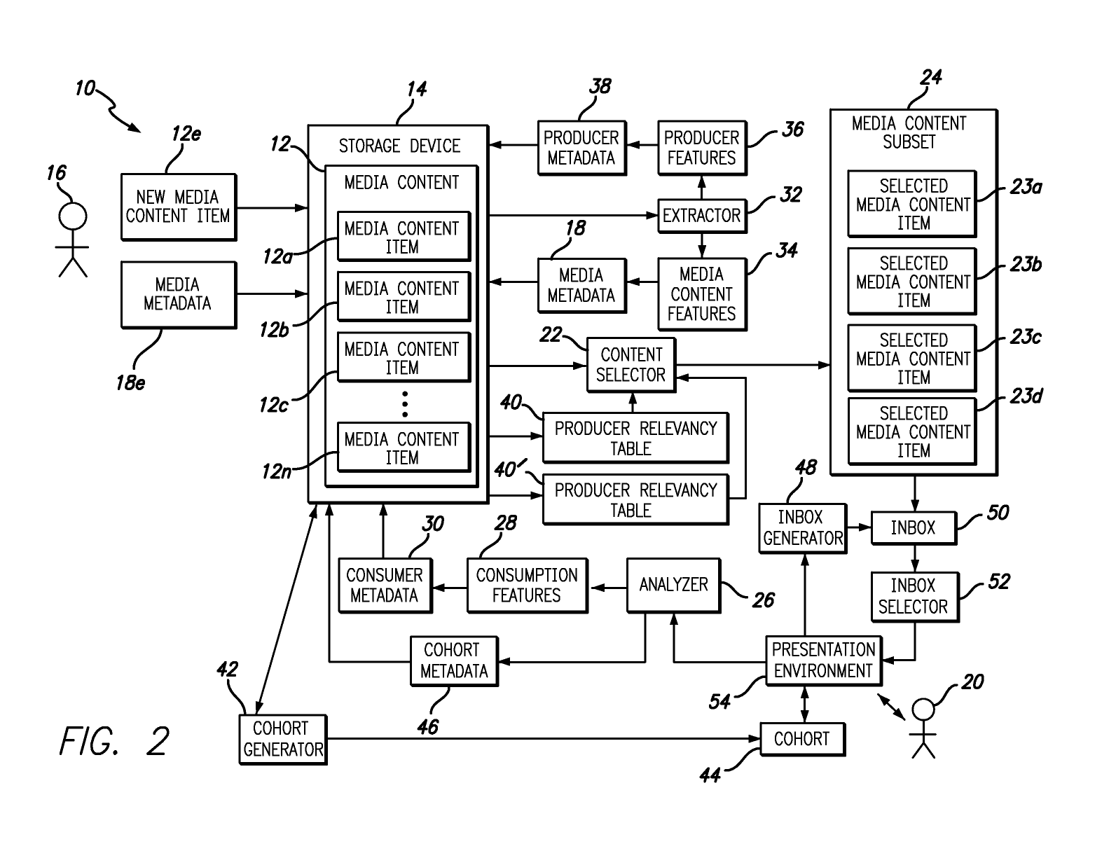

The system 10 further includes one or more producers 16 that create some or all of the individual media content items 12a, 12b, 12c . . . 12n stored on the storage device 14. The one or more producers 16 may be, for example, a human, a machine (e.g., an automated service, a content aggregator, a sensor, or any other non-human agent capable of generating the media content items 12, as described herein), or any combination thereof. Once created, the producer 16 uploads a new media content item (e.g., yet to be uploaded media content item 12e) to the system 10 for storage on the storage device 14. Preferably, the system 10 further stores and associates a set of media metadata 18e with the new media content item 12e. In this respect, each of the media content items 12a, 12b, 12c . . . 12n in the storage device 14 include respective media metadata 18a, 18b, 18c . . . 18n for use in accordance with the embodiments disclosed herein. For example, the media content item 12a would include the media metadata 18a, the media content item 12b would include the media metadata 18b, and so on. In general, the media metadata 18 (FIG. 2) may include both objective and subjective information about the respective media content item 12, such as the name of the producer 16, the creation date, the subject matter, etc. Moreover, the media metadata 18 may include subject matter descriptions that vary from a broad category to more specific or descriptive categories, to more accurately identify the respective media content items 12. For example, the respective media content item 12 may include the relatively broad category “sports”, followed by more specific descriptive categories that include “basketball” and/or “slam dunk”. The media metadata 18 may be embedded and associated with the respective media content item 12 or stored elsewhere on the storage device 14 (e.g., in a media content information registry) and simply associated with the respective media content item 12. Furthermore, the producer 16 may provide the media metadata 18, e.g., by embedding the respective media content item 12 with the media metadata 18 before uploading the respective media content item 12 to the system 10, as illustrated in FIG. 1. Alternatively, the system 10 may extract the media metadata 18 from the respective media content item 12 after upload, as illustrated in FIG. 2.

The content conveyance system 10 also preferably includes one or more consumers 20 who consume some portion of the media content items 12a, 12b, 12c . . . 12n. Like the producers 16, the consumers 20 may be a human, a machine (e.g., an automated process), or any combination thereof. As discussed in greater detail below, the system 10 includes a content selector 22 that selects and retrieves one or more of the media content items 12 for inclusion as a set of selected media content items 23 in a media content subset 24. In the embodiment shown in FIG. 2, the content selector 22 creates the media content subset 24 by specifically selecting the media content items 23a, 23b, 23c, 23d from the media content items 12a, 12b, 12c . . . 12n stored on the storage device 14. In this example, the selected media content item 23a may correspond to the media content item 12a, the selected media content item 23b may correspond to the media content item 12b, the selected media content item 23c may correspond to the media content item 12e, and the selected media content item 23d may correspond to a media content item 12i. This subset 24 of the media content items 12 is later conveyed to and consumed by the consumer 20 in accordance with the embodiments disclosed herein.

The content selector 22 uses information generated by an analyzer 26 in determining which of the media content items 12 to include in the media content subset 24. In this respect, the analyzer 26 is designed to extract a set of consumption features 28 for storage as a set of consumer metadata 30 in connection with the consumer 20. The consumer metadata 30 preferably includes information about the consumer 20, such as age, gender, consumption habits, interests (e.g., “basketball”, “baseball”, “traveling”, etc.), and the like. In one embodiment, the analyzer 26 obtains the consumer metadata 30 by way of information provided by the consumer 20 (e.g., a questionnaire, survey, completing a consumer profile page, voting, rating, annotating one or more of the media content items 12, etc.). Alternatively, the analyzer 26 may extract the consumer metadata 30 from the consumer 20 by way of monitoring and analyzing consumption habits (e.g., keyword searches, watching videos, viewing pictures, etc.), as described in more detail below.

The content selector 22 creates the subset 24 by comparing the consumer metadata 30 with the media metadata 18 for each of the media content items 12a, 12b, 12c . . . 12n on the storage device 14 based on one or more selection criteria. If any of the media content items 12a, 12b, 12c . . . 12n meet the selection criteria, the content selector 22 may select and place matching media content items 12 (e.g., the selected media content items 23a, 23b, 23c, 23d shown in FIG. 2) into the media content subset 24 for later selected consumption by the consumer 20. Conversely, the content selector 22 preferably does not select any of the media content items 12a, 12b, 12c . . . 12n that fail to meet the selection criteria of the subset 24. The selection criteria may be any method known in the art for determining similarity (or lack thereof) between two different sets of metadata (e.g., the media metadata 18 and the consumer metadata 30). For example, the content selector 22 may select and place certain media content items 12 into the media content subset 24 only if there is an exact match between keywords or phrases in the two sets of metadata 18, 30 (e.g., the keyword “basketball” may need to be in both the media metadata 18 and the consumer metadata 30). Alternatively, the content selector 22 may use more inclusive selection criteria. For example, if the consumer metadata 30 includes a keyword for a specific sport (e.g., “basketball”), the content selector 20 may include in the subset 24 all media content items 12 having the metadata 18 containing keywords for any type of sport (e.g., “baseball”, “football”, “hockey”, etc.).

In an alternative embodiment, the content selector 22 may further allow the consumer 20 to manually search the media content items 12 via a query or search feature. Such a feature may be used independently or in conjunction with automatically identifying and selecting the media content items 12 without consumer input, as described above. Here, the content selector 22 may compare the consumer-input keywords or strings with the media metadata 18 for each of the media content items 12a, 12b, 12c . . . 12n in the storage device 14. If any of the media content items 12a, 12b, 12c . . . 12n meet the selection criteria, the content selector 22 places the selected media content items (e.g., the items 23a, 23b, 23c, 23d) into the media content subset 24 for selected consumption by the consumer 20. Moreover, the content selector 22 may allow the consumer 20 to search text within text-based content items (e.g., electronic books, magazines, news articles, etc.). The content selector 22 is preferably able to search the substance (e.g., all text) of text-based media content on the storage device 14 to better identify which of the media content items 12 contain the entered keyword or strings. Of course, the content selector 22 could implement a smart search algorithm that does not necessarily require a one-for-one keyword match, but rather searches for and identifies relevant content based on keyword associations, similar to a Google® search.

More specifically, the analyzer 26 preferably analyzes how the consumer 20 consumes the media content subset 24 and stores the analysis results as the consumer metadata 30 associated with each consumer 20. The analyzer 26 determines which of the selected media content items 23 in the media content subset 24 the consumer 20 actually consumes. The analyzer 26 then extracts the consumption features 28 from each of the consumed selected media content items 23a, 23b, 23c and/or 23d and stores these consumption features 28 as keywords or phrases as the consumer metadata 30 for use by the content selector 22 in generating future media content subsets 24. The consumption features 28 extracted from the analyzed media content items in the subset 24 may include, inter alia, the subject matter of the selected media content item (e.g., keywords such as “basketball”, “football”, or more generally “sports”); the people, places, and things portrayed in the consumed selected media content items 23a, 23b, 23c and/or 23d (e.g., location of a video or a specific product mentioned therein); the reputation of the consumed selected media content items 23a, 23b, 23c and/or 23d created by the producer 16; the geographical location of the producer 16; and other media content items 12 viewed by consumers 20 who also view the analyzed and consumed selected media content items 23a, 23b, 23c and/or 23d. Alternately, the analyzer 26 may not extract the consumption features 28 from the consumed media content items 23a, 23b, 23c and/or 23d. Instead, the analyzer 26 may only determine which of the selected media content items 23 the consumer 20 actually consumes, and then uses the media metadata 18 from the consumed selected media content items 23a, 23b, 23c and/or 23d to create the consumer metadata 30.

The content selector 22 preferably automatically creates the media content subsets 24 from the larger collection of the media content items 12a, 12b, 12c . . . 12n in the storage device 14. In this embodiment, the content selector 22 may eliminate the need for input from the consumer 20. That is, the consumer 20 no longer needs to vote on, rate, or otherwise annotate any of the media content items 12 to receive relevant media content subsets 24. For example, relevant interests may include hobbies, age-related interests or groups, geographic locations, or virtually any other categorical area of interest. Furthermore, the media content subsets 24 are highly personalized because selections are based on metadata collected directly from each consumer 20. Thus, the system 10 is not reliant on crowd-sourcing or objective data in selecting relevant media content subsets 24 to present to each consumer 20.

FIG. 2 illustrates additional aspects of the system 10 relative to those shown and described above with respect to FIG. 1. Here, the system 10 may include an extractor 32 for extracting a set of media content features 34 through analysis of the media content items 12a, 12b, 12c . . . 12n on the storage device 14. The media content features 34 extracted by the extractor 32 may include the subject matter of the media content items 12, common words or proper names associated with the media content items 12, the identity of a face in the media content items 12, or any other feature known in the art. In one embodiment, the extractor 32 may extract multiple features 34 from the respective media content items 12 or multiple extractors 32 may extract different features 34 from the respective media content items 12, as described in more detail below with respect to FIG. 5. For example, one extractor may extract the subject matter of the media content item, while another extractor may extract location information from the same media content item.

The extractor 32 may also extract a set of producer features 36 and store this information as a set of producer metadata 38. The producer features 36 may include the name, age, occupation, geographic location, interests, past content item production history, popularity, or any other characteristic relating to the producer 16. The producer metadata 38 may be stored in a producer profile (not shown in FIG. 2) or anywhere else accessible to the system 10.

The system 10 may further optionally include a producer relevancy table 40 that includes a directory or list of the producers 16 who produce the media content items 12 relevant or interesting to a specific consumer 20. The system 10 builds the producer relevancy table 40 by comparing the consumer metadata 30 with the producer metadata 38 based on certain producer relevancy criteria such as, inter alia, objective criteria (e.g., number of downloads or views), popularity (e.g., ratings by other consumers) or similar characteristics (e.g., interests such as basketball, age, geographic location, occupation, etc.). For example, if the consumer metadata 30 of a specific consumer 20 includes the interest “basketball”, the producer relevancy table 40 may include producers who produce media content items 12 related to “basketball”. New producers or producers with little or no information will typically have little to no relevancy until the producer 16 builds a reputation among the consumers 20 based on the content produced. The system 10 may also permit the consumers 20 to manually add producers 16 to the producer relevancy table 40 as needed or desired.

The system 10 may also optionally include a cohort generator 42 that creates one or more cohorts 44. The cohort 44 is essentially a group of the consumers 20 the cohort generator 42 deems similar based on one or more cohort selection criteria. The cohort selection criteria may include, for example, hobbies (e.g., sports or travel), age, gender, political affiliation, or virtually any other method of categorizing or sorting the interests or character information of individual or groups of the consumers 20. Although, preferably, the cohort selection criteria is based, at least in part, on consumption of similar media content items 12. In one example, the cohort generator 42 may create a cohort of democratic consumers and create another cohort of republican consumers. The system 10 may treat each cohort 44 similar to each individual consumer 20 for purposes of creating metadata and extracting relevant content items or features.

More specifically, each cohort 44 may have a set of cohort metadata 46 collected by the analyzer 26 that collectively represents the individual consumption habits of the consumers 20 that make up each cohort 44. Moreover, each cohort 44 may include its own producer relevancy table 40′, again representative of the collective consumption habits of the consumers 20 in the cohort 44. Alternately, each cohort 44 may simply be a group of similar consumers 20 and have no unique group characteristics (e.g., the cohort metadata 46 or the producer relevancy table 40′). The consumers 20 may also belong to multiple cohorts 44. For example, one consumer 20 could be a member of a “basketball” cohort and a member of a “republican” cohort. Alternatively, the system 10 may restrict consumer enrollment to a specific number of the cohorts 44, or to a single cohort 44. Additionally, the system 10 preferably automatically organizes the placement of the consumers 20 in the cohorts 44 based on certain objective data, such as relevancy, popularity, interest, etc., although the consumers 20 may be given the option to manually joint or leave a cohort 44. One benefit is that the cohorts 44 may reduce the number of the media content subsets 24 in the system 10. For example, the system 10 may only need to create a single media content subset 24 representative of a class of consumers, instead of creating a media content subset 24 for each of the consumers 20. Streamlining the creation and conveyance of the media content subsets 24 may reduce the overall processing and bandwidth demands placed on the system 10. In a specific example, instead of generating multiple media content subsets 24 related to the “basketball” media content item 12 for each consumer 20 interested in basketball, the system 10 can group all these consumers 20 into one cohort 44 related to a single “basketball” media content subset 24.

The system 10 may also include an inbox generator 48 for creating one or more inboxes 50 that store the media content subsets 24 of the selected media content 23 for the consumer 20 or the cohort 44. Here, the one or more inboxes 50 may receive and store the media content subsets 24 from the content selector 22 for consumption thereof by the consumers 20 or by consumers subscribing to the cohort 44, as described herein. In one embodiment, the media content subsets 24 related to the interests of the consumer 20 alone or related to the interests of one or more of the cohorts 44 to which the consumer 20 belongs, may be grouped together and delivered to a single inbox 50. In another embodiment, each consumer 20 may have a separate inbox 50 for each interest and/or for each cohort 44. Here, for example, the consumer 20 may have three inboxes 50, one inbox for an individual interest in “basketball”, a second inbox for a first cohort related to “boating” and a third inbox for a second cohort related to “action movies”. Likewise, each cohort 44 may have one inbox 50 shared by all of its member consumers 20, individual inboxes 50 for each of its member consumers 20, or any number of the inboxes 50 as may be desired or needed.

The system 10 may further include an inbox selector 52 for fetching the one or more inboxes 50 for the consumer 20 in response to a request. As mentioned above, each consumer 20 may have several of the inboxes 50 that relate to various interests or cohort memberships. As such, the consumer 20 may have the option of viewing all inboxes at once, a select number of all the inboxes, or the consumer 20 may only be interested in viewing one inbox. Preferably, the inbox selector 52 automatically pre-selects one or more of the inboxes 50 based on a search request by the consumer 20. Here, the consumer 20 need only provide search criteria for the inbox selector 52 to use to identify and present the relevant inboxes 50 to the consumer 20. In another embodiment, the inbox selector 52 may automatically pre-select one or more of the inboxes 50 without input from the consumer 20. Here, the inbox selector 52 may retrieve a newest inbox, a random inbox, an inbox the consumer 20 has never viewed, or any other inbox as the system 10 may be designed to retrieve or fetch. In another alternative embodiment, the consumer 20 may be able to review and manually select one or more of the inboxes, as desired, and the inbox selector 52 retrieves those one or more inboxes accordingly.

The system 10 further includes a presentation environment 54 that conveys all or a portion of the selected media content items 23 in the media content subset 24 and/or the retrieved inboxes 50 for consumption by the consumer 20. The presentation environment 54 may be a computer monitor, television, projector, mobile device (e.g., smartphone or tablet), audio playback device, large-format display in a public venue, or any other type of device or venue for conveying the information described herein. Of course, the nature of the presentation environment 54 may depend on the type of selected media content 23 (e.g., video, audio, text, or picture). Likewise, the specific method of consumption (e.g., watching, listening, or reading) will depend on the type of selected media content 23. The presentation environment 54 may also permit the consumer 20 to ignore certain selected media content 23, vote or rate the selected media content 23, comment on the selected media content 23, or otherwise add metadata.

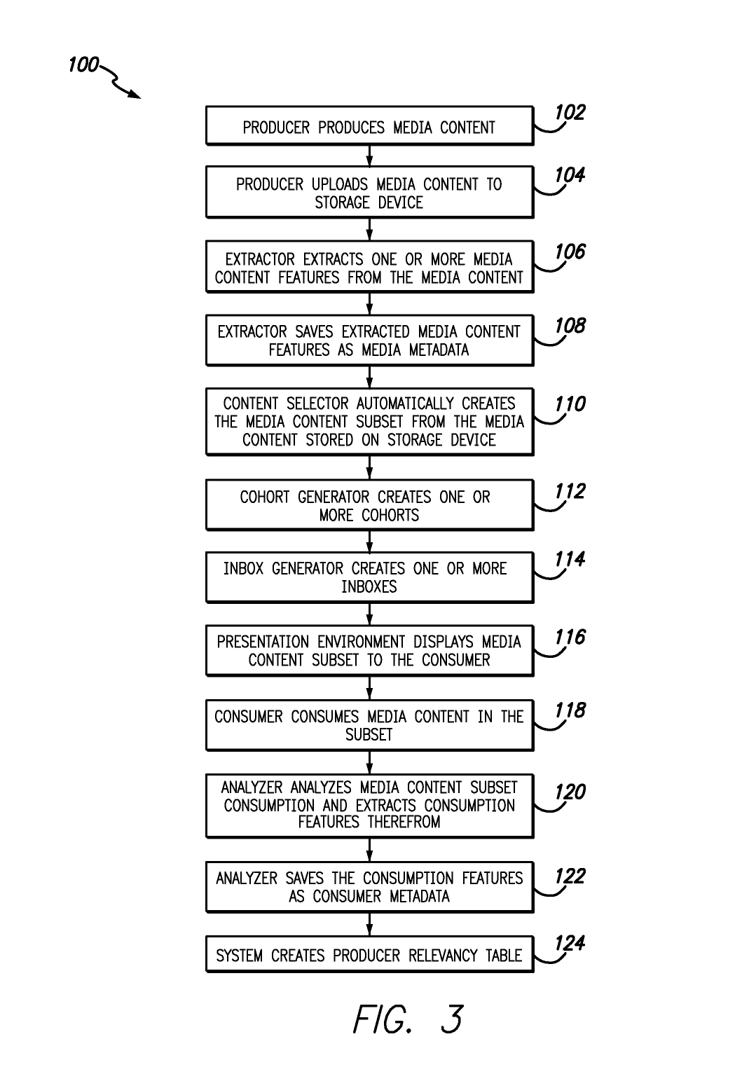

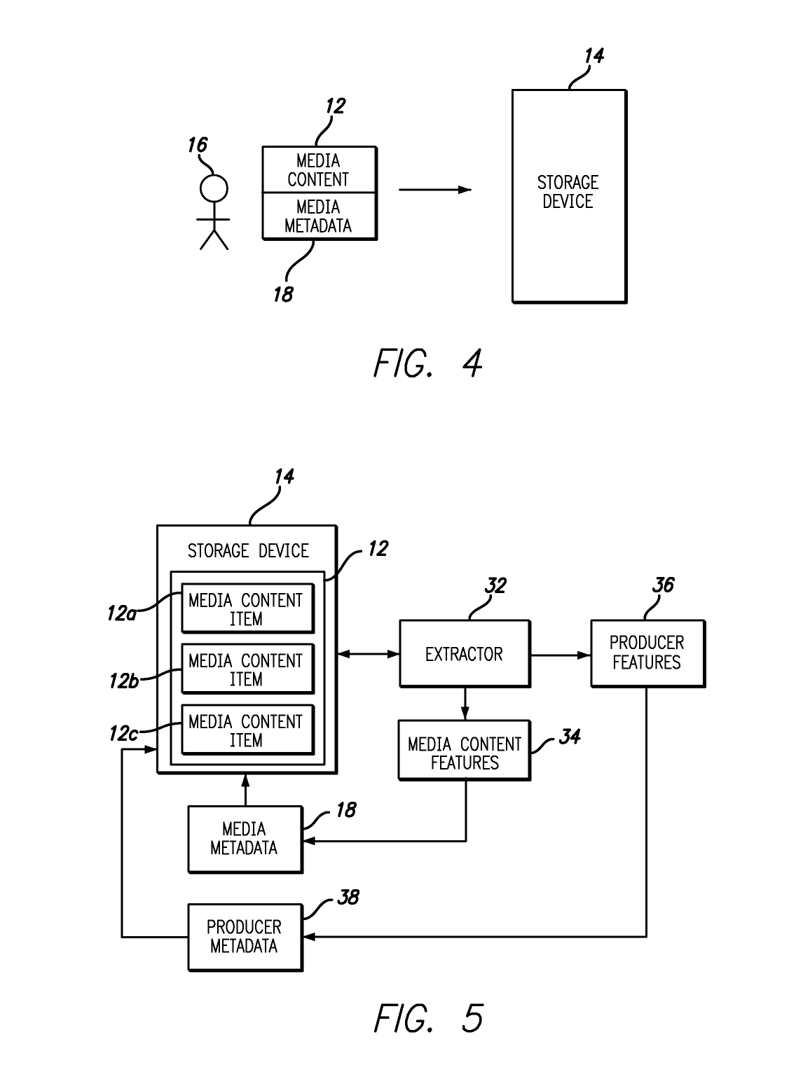

FIG. 3 illustrates one method (100) for conveying the media content subset 24 in accordance with the embodiments disclosed herein. The steps and related apparatuses of method (100) are more specifically shown and described below with respect to FIGS. 4-14. In this respect, the first step (102) is for one or more of the producers 16 to create one or more of the media content items 12. The producer(s) 16 may create the media content item(s) 12, for example, by recording video or audio, taking pictures, writing text, or by other methods known in the art for creating media content for use with the system 10.

The next step (104) is for one or more of the producers 16 to upload the media content items 12 to the storage device 14, as illustrated in FIG. 4. The producer(s) 16 may upload the media content item(s) 12 to the system 10 via the Internet, a local area network (LAN), a virtual private network (VPN) or some other suitable method known in the art for transferring data. The producer(s) 16 may optionally include the media metadata 18 embedded with the respective media content items 12 or otherwise associated therewith, for use by the content selector 22 in creating the media content subsets 24.

In the next step (106), the extractor 32 may optionally extract one or more of the media content features 34 from the media content items 12, as illustrated in FIG. 5. Here, the extractor 32 analyzes the media content items 12 and may extract one or more of the media content features 34 and/or one or more of the producer features 36. In one embodiment, this step (106) may include a single extractor 32 that extracts all the relevant media content features 34 and/or the relevant producer features 36 from the media content items 12. Alternately, step (106) may involve using multiple extractors 32 that extract the same or different media content features 34 from the media content items 12. For example, one extractor may extract subject matter information and another extractor may extract location information. Although, it may not be necessary to perform step (106) if the producer(s) 16 include the media metadata 18 embedded or associated with the respective media content items 12 when the content items 12 are uploaded as part of step (104). Alternatively, the system 10 may still perform step (106) to augment, supplement or check the accuracy of the media metadata 18 provided by the producer(s) 16.

The next step is for the extractor 32 to save the media content features 34 and/or the producer features 36 as metadata (108). More specifically, as illustrated in FIG. 5, the extractor 32 may save the media content features 34 as the media metadata 18 and the producer features 36 as the producer metadata 38. The media metadata 18 may be embedded with the media content items 12 or saved elsewhere on the storage device 14 (e.g., in a media metadata registry) while remaining associated with the media content items 12. Moreover, the media metadata 18 embedded with media content items 12 (FIG. 1) by the producer 16 may also be copied into or placed in the media metadata registry (not shown). In an embodiment wherein the system 10 uses one extractor 32, the media content features 34 and/or the producer features 36 extracted as part of step (106) may simply be respectively saved to the media metadata 18 and/or the producer metadata 38 as shown in FIG. 5.

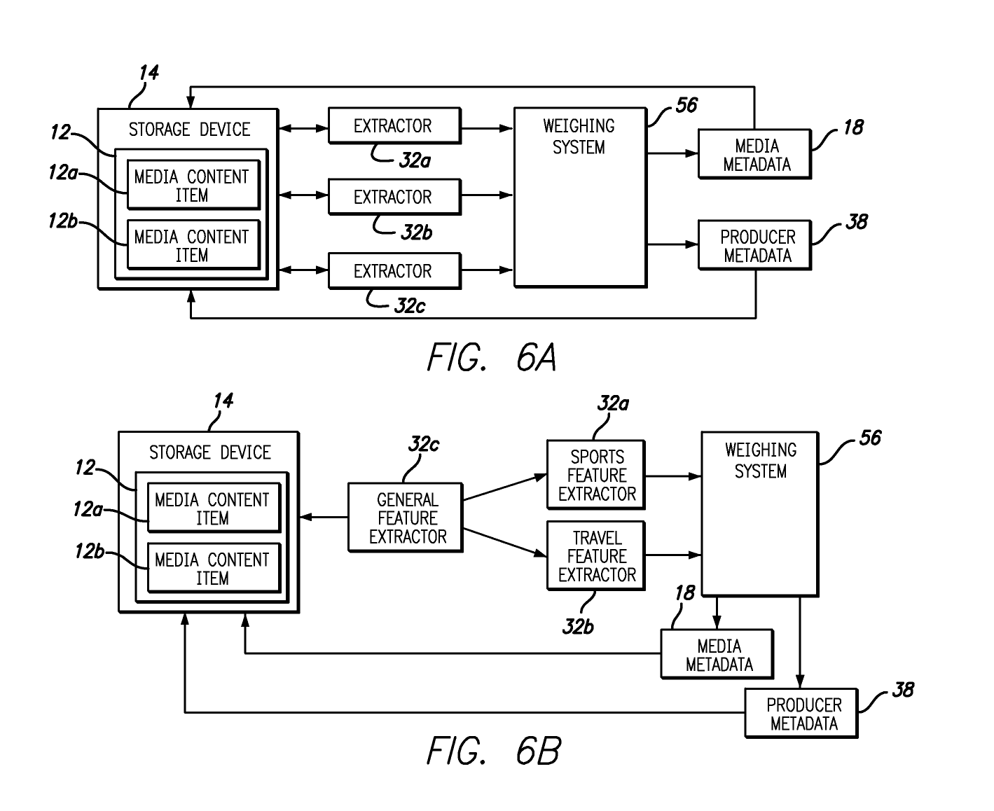

In another embodiment wherein the system 10 uses multiple feature extractors 32, a weighing system 56 may optionally aggregate the results of the multiple feature extractors 32 to provide enhanced categorization. In this respect, the weighing system 56 may accord more or less weight to specific features obtained by the multiple extractors 32 based on the relevancy of the subject matter to the respective extractor. For example, in one embodiment, the system 10 may use three feature extractors, such as a sports feature extractor 32a, a travel feature extractor 32b, and a general feature extractor 32c, as illustrated in FIGS. 6A and 6B. In FIG. 6A, the sports feature extractor 32a is optimized for sports-related media content, and thus is relatively accurate when extracting sports-related features, but may be relatively inaccurate with non-sports-related features. Similarly, the travel feature extractor 32b may be optimized for travel-related features, but not for non-travel-related features. Conversely, the general feature extractor 32c is a generalized feature extractor, and is not optimized for any specific type of media content item 12. When extracting the media content features 34 and/or the producer features 36 from a “basketball” video, the weighing system 56 may accord the sports feature extractor 32a the most weight, followed by the general feature extractor 32c, and the travel feature extractor 32b may be given the least weight. Conversely, when extracting features from a “travel” video, the weighing system 56 may give the travel feature extractor 32b the most weight, followed by the general feature extractor 32c, and the sports feature extractor 32a may be given the least weight. As such, the weighing system 56 improves the accuracy of step (108) by giving priority to the specific feature extractor 32 optimized for reading information from the media content items 12. In this respect, the content selector 22 may generate the media content subset 24 based on the weight of the media metadata 18 and/or the producer metadata 38 stored on the storage device 14 in association with respective media content items 12.

Alternatively, the general feature extractor 32c may determine the general category of a feature (e.g., “basketball” or “travel”), and the more specialized feature extractors 32a, 32b may extract the media content features 34 and/or the producer features 36 to be saved as the metadata 18, 38, as illustrated in FIG. 6B. For example, the general feature extractor 32c would decide the overall category of the media content item 12, then the sports feature extractor 32a would extract the media content features 34 and/or the producer features 36 if the media content item 12 is sports-related, or the travel feature extractor 32b would extract the media content 34 and/or the producer features 36 if the media content item 12 is travel-related. In this embodiment, the weighing system 56 may be able to better assign a specific weight to the media metadata 18 and/or the producer metadata 38 based on tailored extraction from the media content items 12.

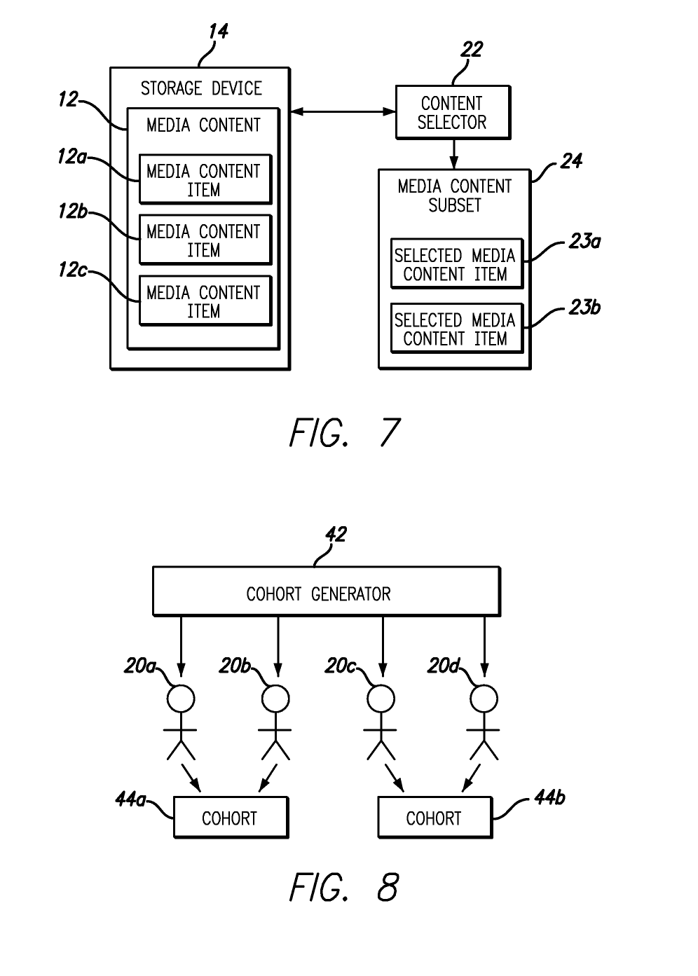

The next step (110) is for the content selector 22 to create the content media subset 24 of the selected content media content items 23 relevant to the consumer 20, as illustrated in FIG. 7. As discussed in greater detail above, the content selector 22 compares the media metadata 18 with the consumer metadata 30 from the media content items 12 based on one or more selection criteria, such as a consumer consumption profile. The media content item(s) 12 meeting the one or more selection criteria become the selected content media 23 and are placed into the content media subset 24. The system 10 excludes other media content items 12 from the subset 24 that otherwise fail to meet the selection criteria. In one embodiment, the consumer 20 may manually search for media content items 12 to place in the content media subset 24 via a query or search. The content selector 22 may only compare the media metadata 18 to the search terms or may compare the media metadata 18 to both the search terms and the consumer metadata 30. Moreover, the content selector 22 may search the text of text-based content items to determine if any of the content items 12 meet the selection criteria. The media content subset 24 may contain only selected media content 23 based on the personal preferences of the consumer 20, the preferences of the cohort 44, or a combination thereof.

The next step (112) is to optionally use the cohort generator 42 to group the consumers 20 having similar consumer metadata 30 (i.e., consumers 20 who share similar interests or characteristics) into the cohorts 44. For example, as illustrated in FIG. 8, the cohort generator 42 groups the consumers 20a, 20b in the cohort 44a and the consumers 20c, 20d into the cohort 44b. The system 10 may continuously add and/or remove the consumers 20 from the cohorts 44 and create and/or delete the cohorts 44 based on changes in the consumption patterns of the selected media content 23. In one aspect, the system 10 may change the structure of the cohort 44 if consumers of a particular cohort 44 begin exhibiting differing content consumption habits (e.g., one group of cohort members consume a particular media content item, while another group of members in the same cohort ignore that particular media content item). Alternatively, the system 10 may change the cohort 44 in response to receiving differing feedback on the consumed selected media content 23 (e.g., one group of cohort members provide positive feedback while another group of members in the same cohort provide negative feedback). If the differing content consumption or feedback patterns are limited to a small number of consumers in the cohort 44, the system 10 may remove these consumers from the cohort 44. If a larger portion of the cohort 44 exhibits different content consumption patterns or provides differing feedback, the system 10 may split the existing cohort 44 into different cohorts so the two new cohorts are representative of the content consumption or feedback tendencies. The cohorts 44 can also be combined when the system 10 determines that two or more of the cohorts 44 are sufficiently similar to one another (e.g., exhibit similar consumption habits and/or provide similar feedback).

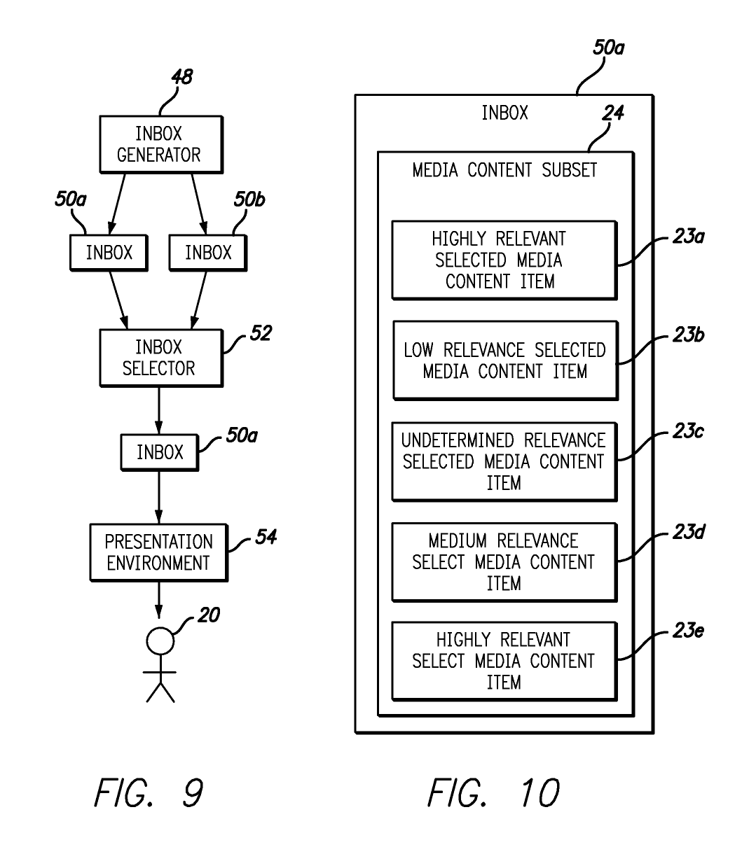

In the next step (114), the inbox generator 48 may create one or more inboxes 50 for storing the one or more of the media content subsets 24. For example, FIG. 9 illustrates the inbox generator 48 creating the inboxes 50a, 50b. In a preferred embodiment, the inbox generator 48 continuously creates new inboxes 50 containing different media content subsets 24 without requiring input by the consumer 20. Thus, as soon as the consumer 20 logs on to the system 10, one or more of the inboxes 50 containing the media content subsets 24 are ready for consumption. In this respect, as shown in FIG. 9, an inbox selector 52 may select one inbox (e.g., the inbox 50a) for presentation to the consumer 20 through the presentation environment 54. Alternatively, the inboxes 50 may be generated on-demand when requested by the consumer 20 or may be static.

As illustrated in FIG. 10, the media content subsets 24 stored in the inbox 50a include a mixture of “high” relevancy (e.g., the selected media content 23a, 23e), “medium” relevancy (e.g., the selected media content 23d), and “low” relevancy (e.g., the selected media content 23b) selected media content items, including some items 23 identified as having an “undetermined” relevancy (e.g., the selected media content 23c). This arrangement is advantageous over a system that only presents highly relevant media content because displaying only highly relevant media content tends to produce increasingly narrow and self-reinforcing media content subsets 24 over time, thereby preventing the serendipitous discovery of new media content. Thus, the system 10 may update the consumer metadata 30 when the consumer 20 consumes selected media content 23 the system 10 previously determined was irrelevant, to further increase the future accuracy of the system 10. Alternately, in general, the inbox 50 may contain more homogeneity in the selection of the selected media content 23. For example, the inbox 50 may include only highly-rated media content or only media content matching a keyword search or phrase.

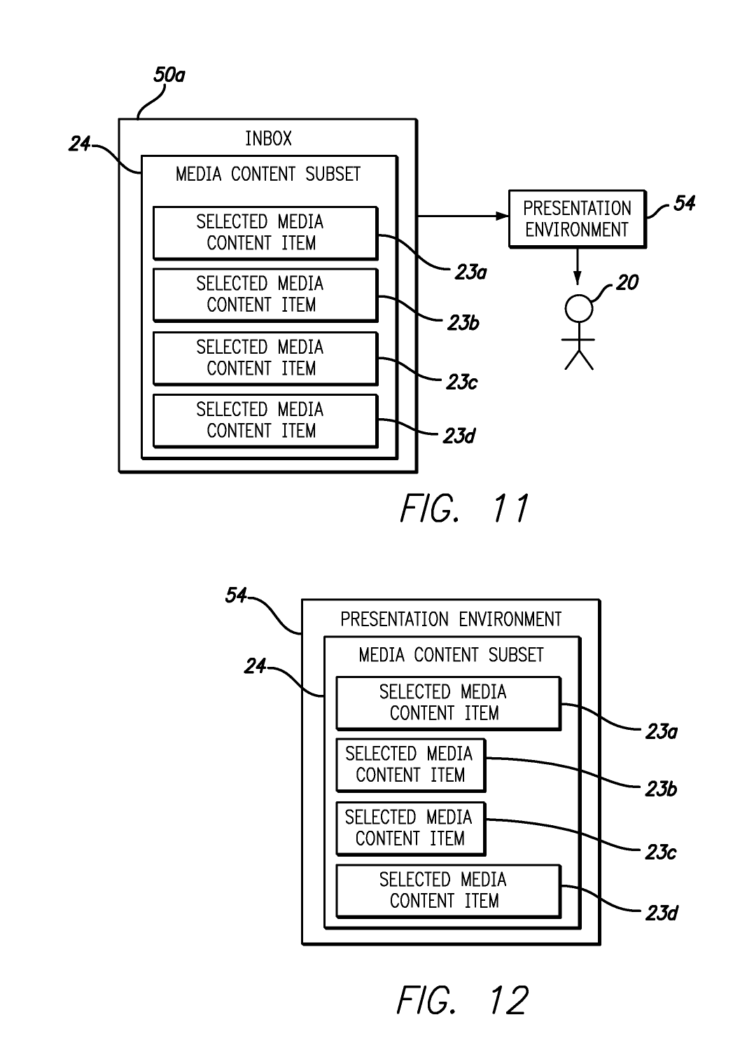

The next step (116) is for the presentation environment 54 to convey the media content subsets 24 stored in the one or more inboxes 50 to the consumer 20 for consumption thereof, as illustrated in FIG. 11. The media content subset 24 may be conveyed visually, audibly, or in any combination thereof. The particular method for conveying the selected media content 23 may vary depending on the type of the selected media content 23. For example, a song or other sound recording may be conveyed only audibly (e.g., via an MP3 player without a screen). A picture may be conveyed only visually (e.g., via a display screen without speakers). More preferably, however, the selected media content 23 in the media content subset 24 is presented (or presentable) both visually and audibly (if necessary), such as by a computer, tablet or smartphone. Should the consumer 20 have more than one inbox 50 containing different media content subsets 24, the inbox selector 52 may determine which one or more of the inboxes 50 to convey through the presentation environment 54. For example, in FIG. 9, the inbox selector 52 selected and conveyed the inbox 50a to display to the consumer 20. Alternately, the consumer 20 may manually select or determine the inboxes 50 conveyed by way of the presentation environment 54.

In a preferred embodiment, the presentation environment 54 presents the media content subset(s) 24 in a continuously moving stream. Here, the selected media content 23 may start to appear at the bottom of the presentation environment 54 (e.g., a display screen), travel up the presentation environment 54, and exit the top side thereof, or vice versa. The media content subset(s) 24 may also move horizontally across the presentation environment 54 (e.g., from right-to-left or left-to-right). In an alternate embodiment, the presentation environment 54 may present the media content subset(s) 24 in a scrollable list the consumer 20 can navigate manually via a mouse, touch screen, track pad, stylus, or other similar device. As illustrated in FIG. 12, relevancy may determine the size of the selected media content 23 presented to the consumer 20. Here, the selected media content items 23a and 23d may be considered more relevant than the selected media content items 23b and 23c, as represented by the relative size of the boxes in FIG. 12. This methodology of presenting the selected media content 23 to the consumer 20 may assure that more relevant content receives more attention than less relevant content, while simultaneously still presenting a diverse content base of information to the consumer 20. That is, the more relevant media content (e.g., the selected media content items 23a, 23d) are larger and consume more of the presentation environment 54 display space than the less relevant media content (e.g., the selected media content items 23b, 23c).

Additionally, the presentation environment 54 may include a summary feature (e.g., a new window or pop-up box) that presents a selectable short description of the selected media content items 23a-23d presented to the consumer 20. Here, the consumer 20 may interact with the selected media content items 23a-23d in some respect, such as hovering over one of the selected media content items 23a, 23b, 23c, or 23d with a mouse or comparable pointing device. This may allow the consumer 20 to quickly view a brief description of the selected media content item 23a, 23b, 23c, or 23d before deciding whether to select or ignore the hovered-over item. Moreover, the system 10 may track the interaction level of the consumer 20 with each of the selected media content items 23a-23d. In this respect, the system 10 may determine instances where the consumer 20 simply ignores the selected media content items 23a-23d, previewed the selected media content items 23a-23d, or consumed one or more of the selected media content items 23a-23d (e.g., by clicking or touching the selected media content item 23b).

The preview feature of the system 10 is preferably implemented in a way that does not clutter the presentation environment 54. For example, the consumer 20 may position a pointing device (e.g., a computer mouse, stylus, finger or the like) over the selected media content 23 or click on the desired selected media content 23 to display a short summary. The consumer 20 may then click on the selected media content to view it fully. Thus, the consumer 20 can quickly obtain a preview or short description of the selected media content 23 without taking the time to fully consume the selected media content 23. Alternatively, the summary may be displayed in the presentation environment 54 without any interaction with the selected media content 23 by the consumer 20.

The next step (118) is for the consumer 20 to consume one or more of the selected media content items 23a-23d from the media content subset 24 conveyed to the consumer 20 by way of the presentation environment 54. The specific method of consumption of each of the selected media content items 23a-23d may vary depending on the type and structure thereof. Such consumption may include, inter a/ia, reading text, viewing photos or videos, and/or listening to audio.

The next step (120) is for the analyzer 26 to analyze consumption of the selected media content 23a, 23b, 23c, or 23d in the media content subset 24 by the consumer 20. As illustrated in FIG. 13, the analyzer 26 first determines which of the selected media content 23a, 23b, 23c, or 23d in the media content subset 24 the consumer 20 consumed by way of the presentation environment 54. Next, the analyzer 26 extracts various consumption features 28 from the consumed media content 23a, 23b, 23c, or 23d and stores the consumption features 28 as the consumer metadata 30 for use by the content selector 22 in generating future media content subsets 24. In an alternate embodiment, the analyzer 26 may only record which selected media content 23a-23d the consumer 20 consumed. The system 10 then uses the media content features 34 in the media metadata 18 as the consumption features 28. Here, the system 10 can use the media metadata 18 to obtain the consumption features 28 if the analyzer 26 does not extract the consumption features 28 from the consumed media content 23.

The next step (122) is to save the consumption features 28 extracted by the analyzer 26 as the consumer metadata 30 for later use by the content selector 22. In one embodiment, all the consumption features 28 are saved as the consumer metadata 30. More preferably, however, the system 10 saves the consumption features 28 as the consumer metadata 30 only if that information has been extracted some threshold number of times. For example, the consumption features 28 (e.g., “basketball”) must be extracted from the media content item 12 five times before the analyzer 26 will save that consumption feature 28 as the consumer metadata 30. Thus, random or coincidental consumption features extracted from the consumed media content 23 that do not interest the content consumer 20 will not be used by the content selector 22 when generating future subsets 24. For example, if the consumer 20 views a video of a basketball game in New York, the analyzer 26 may extract the phrase “basketball” as a feature and the phrase “New York” as a feature. Moreover, this particular consumer 20 may be an avid basketball fan, but may have no interest in New York. Thus, assuming this consumer 20 has watched numerous other basketball videos (e.g., five) and few, if any, New York videos (e.g., one), only the feature “basketball”, and not “New York”, will be saved in the consumer metadata 30 for use by the content selector 22. In this example, the phrase “basketball” meets the minimum threshold selection requirement seeing that the consumer 20 has watched five basketball videos, while the phrase “New York” fails to meet the minimum threshold selection requirement and is deemed merely a coincidental feature that does not interest the consumer 20. Therefore, only consumption features 28 common to the types of selected media content 23 repeatedly consumed enough to warrant a reasonable likelihood of actual interest (e.g., basketball videos) will be used to create future media content subsets 22. The same logic and features can be applied to consumption habits by the cohorts 44.

Moreover, the analyzer 26 may give more weight to the consumption features 28 extracted from the selected media content items 23 that the consumer 20 spent a longer time consuming. For example, if the consumer 20 spent ten minutes watching a first video and five minutes watching a second video, the analyzer 26 may give more weight to the consumption features extracted from the first video than the consumption features extracted from the second video when determining if the threshold for saving in the consumer metadata 30 has been met. Alternatively, the time requirement may be based on a percentage of the media content consumer since some content may last longer than others. The analyzer 26 may update the consumer metadata 30 in real-time (i.e., in response to every selected media content consumption action that the consumer 20 takes) or at certain intervals (e.g., certain times of the day or week). The consumer metadata 30 may be saved anywhere accessible to system 10 (e.g., in a content consumer metadata registry or simply on the storage device 14).

Importantly, the analyzer 26 does not require any input from the consumer 20. Preferably, the analyzer 26 operates automatically behind the scenes to extract the consumption features 28 from the consumed selected media content 23. Thus, the consumer 20 need not vote on, rate, annotate, or otherwise provide any input to the system 10 as the analyzer 26 extracts and stores the relevant data as the consumer metadata 30—such extraction preferably occurs in real-time as consumers consume media content through the system 10. As such, the consumer 20 will receive relevant media content subsets 24 simply by consuming the selected media content 23 and defined user feedback is not necessarily needed for the system 10 to operate. Advantageously, the media content subsets 24 presented by the system 10 are highly personalized unlike traditional systems that group media content items 12 based on objective or crowd-sourced data. This is because the analyzer 26 analyzes consumer content consumption habits and stores the relevant data (i.e., the consumption features 28) as the consumer metadata 30 for that specific consumer 20 (or for a cohort 44). The specific consumer metadata 30 is then used to create the media content subset 24 for that specific consumer 20 or specific cohort 44. No other consumer preferences, viewing habits, or opinions need be taken into account when creating the media content subset 24. In this respect, the media content subset 24 is highly representative of consumer or cohort preferences.

Even though the above-described features of the system 10 eliminate the need for consumers to input data to create the media content subsets 24, the consumption features 28 may still optionally include various consumer 20 annotations (e.g., voting, rating, or commenting on consumed selected media content items 23). These consumer 20 annotations may still be an integral part in forming the consumer metadata 30 or the cohort metadata 46.

In one embodiment, crowd-sourced measures of popularity (e.g., content consumer rating) may be a factor in determining media content item relevancy by the content selector 22. The content selector 22 may be more likely to place highly-rated media content into the media content subset 24 than lower-rated media content, all else being equal. For example, if the producer 16 creates a new media content item 12e (FIG. 1), that media content item 12e may be consumed and annotated (e.g., rated) by a number of the consumers 20. If the consumers 20 favorably rate the new media content item 12e, it will be more likely to appear in the media content subset 24 than other media content items less favorably rated by the consumers 20. Thus, highly-rated media content items are more likely to be consumed than lower-rated media content items. In this respect, popular media content items preferably quickly replicate through the media content subsets 24 and the inboxes 50 of the consumers 20 and the cohorts 44 in the system 10, while unpopular media content items (e.g., spam or other undesirable content) quickly die off as a result of being excluded from the media content subsets 24, and the inboxes 50.

Importantly, consumers employing false account schemes or botnets solely for the purpose of rating media content items 12 up or down will be placed in their own cohort 44, and thus not disrupt the experience of legitimate consumers. These botnet-type “consumers” create their own consumption patterns or are placed in their own cohort and thereby segregated from legitimate consumers. Thus, the botnet-type “consumer” or cohort will receive different selected media content 23 in its media content subset 24 than the legitimate consumers 20 and the legitimate cohorts 44. That is, the media content items 12 the botnet-type “consumers” rate up will appear in a media content subset and inbox associated only with that consumer or a cohort made up of the botnet-type “consumers”, while those same media content items will not be conveyed to other consumers or cohorts because the consumption habits would be different. Moreover, the more these botnet-type “consumers” try to favorably rate particular media content items, the more the “consumers” and their cohort become segregated from legitimate consumers. In this respect, the system 10 ameliorates the effects of botnets, griefing, spamming and other unauthorized and undesirable uses thereof.

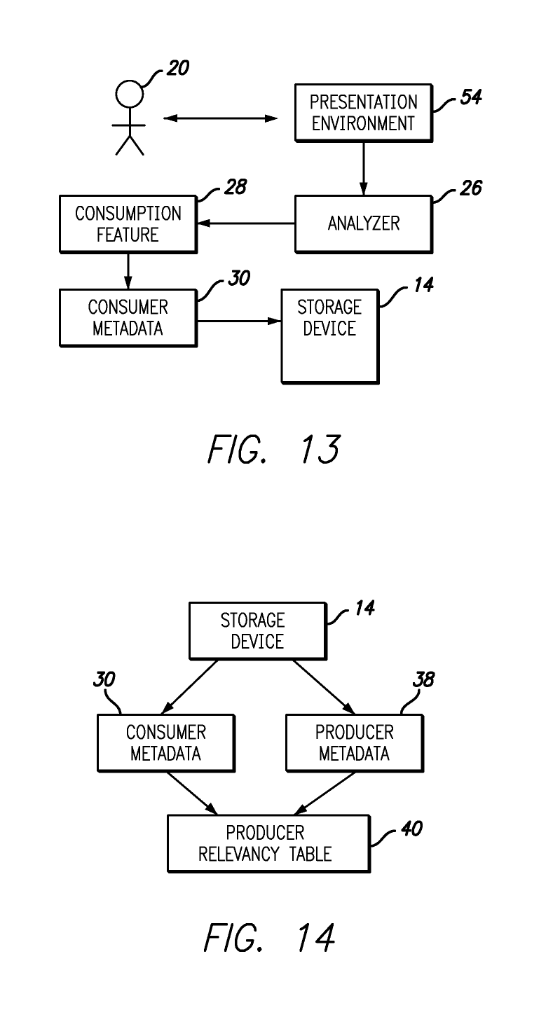

In step (124), the system 10 may optionally create the consumer relevancy table 40 based on the consumption features 28, as illustrated in FIG. 14. To do so, the system 10 compares the consumer metadata 30 with the producer metadata 38 based on one or more producer relevancy criteria. The content selector 22 may use the producer relevancy table 40 as a factor in creating the media content subsets 24. Thus, the media content items 12 created by the producers 16 listed on the producer relevancy table 40 are more likely to appear in the media content subset 24 for the consumer 20 or the cohort 44 than the media content items 12 produced by the producers 16 not listed on the relevancy table 40. The consumer 20 may also manually add producers to the producer relevancy table 40.

Although several embodiments have been described in detail for purposes of illustration, various modifications may be made without departing from the scope and spirit of the invention. Accordingly, the invention is not to be limited, except as by the appended claims.

What is claimed is:

1. A method for conveying automatic passive interest classified media content, comprising the steps of:
storing a plurality of media content items on a storage device;
associating metadata with each of said media content items in said storage device;
creating a media content subset from said plurality of media content items;
conveying said media content subset over a communication network to an interactive presentation environment for consumption by a user;
analyzing consumption of said media content subset by said user over said interactive presentation environment; and
modifying said media content subset from said plurality of media content items in said storage device in response to said analyzed user consumption.

2. The method of claim 1, wherein said analyzing step includes the step of identifying consumption habits through user interaction with said interactive presentation environment and associating said habits as said metadata with respective consumed media content items.

3. The method of claim 1, wherein said modifying step includes the step of removing unconsumed media content items from said media content subset.

4. The method of claim 1, wherein said storage device comprises a local storage medium, a network-connected storage medium, or a cloud service.

5. The method of claim 1, wherein said plurality of media content items comprise audio content, visual content, or a combination of audio and visual content.

6. The method of claim 1, including the step of receiving an uploaded media content item having a set of pre-loaded metadata.

7. The method of claim 1, wherein said metadata comprises a producer metadata, a consumer metadata or a category metadata.

8. The method of claim 1, wherein said creating step includes the step of selecting one or more of said plurality of media content items for inclusion in said media content subset based on an input received from said user through said interactive presentation environment.

9. The method of claim 1, including the step of forming a producer relevancy table.

10. A method for conveying automatic passive interest classified media content to a cohort, comprising the steps of:
storing a plurality of media content items and associated metadata on a storage device;
creating a media content subset from said plurality of media content items based on similarities in said metadata;
forming said cohort with users having similar consumption habits;
conveying said media content subset over a communication network to an interactive presentation environment for consumption by one or more users of said cohort;
analyzing consumption of said media content subset by said one or more users over said interactive presentation environment; and
modifying said media content subset from said plurality of media content items in said storage device in response to said analyzed consumption of said media content subset by said one or more users in said cohort.

11. The method of claim 10, including the step of generating cohort metadata for each of said plurality of said media content items based on said consumption habits of said users of said cohort.

12. The method of claim 10, including the steps of forming multiple cohorts and associating a producer relevancy table with each cohort.

13. The method of claim 10, including the step of assigning multiple cohorts to a user.

14. The method of claim 10, including the step of changing the consumption habits of a user of said cohort in response to said user's consumption of said media content subset through said interactive presentation environment.

15. The method of claim 14, including the step of removing at least one user from said cohort when consumption habits of said removed user are no longer similar with the consumption habits of said cohort.

16. A method for conveying automatic passive interest classified media content to a user, comprising the steps of:
storing a plurality of media content items and associated metadata on a storage device;
creating multiple media content subsets from said plurality of media content items, said media content items in each of said media content subsets having related metadata;
conveying one or more of said media content subsets over a communication network to at least one media inbox associated with said user through an interactive presentation environment;
analyzing media inbox selection and consumption of said respective media content subsets therein by said user over said interactive presentation environment; and
modifying said consumed media inbox and media content subset based on user selection and consumption habits with said consumed inbox and said media content subset over said interactive presentation environment.

17. The method of claim 16, wherein said media inbox comprises a consumer inbox and a cohort inbox.

18. The method of claim 16, including the step of assigning multiple media inboxes to said user.

19. The method of claim 16, wherein the conveying step includes the step of conveying a pre-selected inbox, a search inquiry inbox, an objective criteria inbox, or a manually selected inbox to said user.

20. A method for conveying automatic passive interest classified media content to a user in a feedback responsive presentation environment, comprising the steps of:
storing a plurality of media content items and associated metadata on a storage device;
creating a media content subset from said plurality of media content items based on a consumption habit profile unique to said user;
conveying said media content subset over a communication network to said feedback responsive presentation environment;
analyzing interaction of said conveyed media content items from said media content subset by said user within said feedback responsive presentation environment; and
modifying said consumption habit profile of said user in response to consumption or non-consumption of said media content items in said media content subset conveyed to said user in said feedback responsive presentation environment.

21. The method of claim 20, wherein said modifying step further includes modifying said media content items in said media content subset in response to modification of said consumption habit profile of said user.

22. The method of claim 20, wherein said feedback responsive presentation environment comprises a continuously moving stream of said media content items.

23. The method of claim 22, wherein said continuously moving stream comprises a horizontal stream, a vertical stream, or a manually scrollable stream.

24. The method of claim 20, wherein said media content items relatively more pertinent to said user are more prominent in said feedback responsive presentation environment than other media content items relatively less pertinent to said user.

25. A method for conveying automatic passive interest classified media content, comprising the steps of:
storing a plurality of media content items and associated metadata on a storage device;
extracting at least one feature from one or more of said media content items;
creating a media content subset from said plurality of media content items based at least in part on similar features extracted from said media content items;
presenting said media content subset over a communication network to an interactive presentation environment for consumption by a user;
analyzing consumption of said media content subset by said user over said interactive presentation environment; and
modifying said media content subset with said plurality of media content items from said storage device in response to said analyzed user consumption.

26. The method of claim 25, including the step of augmenting said metadata with said at least one feature.

27. The method of claim 25, wherein said at least one feature comprises a producer feature or a media content feature.

28. The method of claim 25, including the steps of comparing said extracted at least one feature with said metadata and supplementing said metadata with said extracted at least one feature when non-duplicative.

29. The method of claim 25, wherein said extracting step includes the step of extracting a first feature from said media content item with a first extractor and extracting a second feature from said media content item with a second extractor.

30. The method of claim 29, including the step of weighing said first and second features based on the relevancy of said first and second extractors relative to said first and second features, wherein a higher relevancy corresponds with a higher weight.
